(19) United States
(12) Patent Application Publication
(10) Pub. No.: US 2009/0327539 A1
(43) Pub. Date: Dec. 31, 2009

(54) Multiple Die System Status Communication System

(76) Inventors: Tommi Kanerva, Tampere (FI); Pasi Kolinummi, Kangasala (FI); Mika Koikkalainen, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/164,785

(22) Filed: Jun. 30, 2008

(51) Int. Cl. G06F 13/00

(52) U.S. Cl. 710/104

(57) ABSTRACT

Suitably arranged circuits located on a die surface are operatively connected via a shared link which is configured for carrying data information content between the suitably arranged circuits. A suitably arranged and configured system status signal is transferred between a first of the suitably arranged circuits and a second of the suitably arranged circuits via the shared link for mirroring a system status of the first of the suitably arranged circuits in the second of the suitably arranged circuits.

In one embodiment, the system status signal is arranged and configured as part of the data information content data packet structure carried between the suitably configured circuits. The system status signal comprises a collection of bit signals arranged and configured for indicating a status of a corresponding on-chip-interconnect access in the first of the suitably arranged circuits. The collection of bit signals in the second of the suitably arranged circuits are converted for updating in the second of the suitably arranged circuits the status change to the on-chip-interconnect accesses in the first of the suitably arranged circuits. The shared link is configured as a fragmented data interconnect link or as a high-speed synchronous serial interface link.

### FIELD OF TECHNOLOGY

The present invention relates generally to the field of electronics and application specific integrated circuit design. More particularly the present invention relates to the field of multiple die interconnection and data transfer between multiple dies.

The present invention is also related to application specific integrated circuit system status transfer from one die to another die without dedicated application specific integrated circuit inputs/outputs and may be used with in any situation with a limited number of signals or leads between devices.

The present invention is further related to application specific integrated circuit system status transfer to an off-die module through a shared (many users) off-die link. More specifically the present invention relates to mirroring of the system status from one circuit on a die surface to another circuit on a die surface via the shared link.

### BACKGROUND

There are situations in which a system, device, node, access point, base station, mobile station and the like will be implemented with multiple dies in a package such as, for example, an application specific integrated circuit (ASIC), field programmable gate array (FPGA) or some other suitable package system. Such multiple die implementations are, for example, common in system development as well as for products without sufficiently high volumes and provide flexibility for development because one platform can be used in multiple ways. In contrast to multiple die implementations for low volume products, monolithic die integration is usually preferred for very high volume products. The system may also be divided into multiple independent parts, including inside one system-on-chip application specific integrated circuit, which has a limited number of signals or leads between the multiple independent parts. The dies may be stacked together which is known as 3D integration or they may be completely separate. In multiple die implementations, there must be a way to provide communication and interconnection between the dies in the multiple die system design.

One known multiple die data communication link design uses the same data path for data that is transmitted and received between the dies. In non-posted writes and reads [a first command is initiated (a transmit signal) and then a response (a receive signal) is received back], the other potential link users i.e. other circuits for example on the dies, are not able to utilize the link when an access is pending, which leads to a less than optimal or desired throughput. In other words, during the time the link is waiting for response, it is not transmitting any real data and cannot transmit any data until such time as the destination gives the response.

In multiple die system implementations, for example, one where all the general purpose processing power is on one die and modules on another die require off-die processor control, the control requirement is signaled by module driven status signals. The status signals can be for example, interrupts or direct memory access request signals. The needed number of status signals implemented as direct off-die connections is in the range of 50 to 100. In application specific integrated circuit implementation input/output pins or leads are generally considered to be expensive and a unique resource not to be wasted. Further, the direct status signal mapping to application specific integrated circuit inputs/outputs is well beyond that which can be tolerated. Similar problems will also be present for both stacked die and discrete die system solutions and also partially inside dies with multiple voltage domains in which there might be more signals crossing voltage domains.

The die's internal signal connection count between functional entities is almost free i.e. there can be literally thousands of signals without any problem. The signal connections between dies are quite expensive, thus the link count is limited and the pin count is heavily optimized. When the functionality is split into two dies, the data communication link between the two dies is often one of the bottlenecks of the design. Some drawbacks presented by the data communication link design include for example, additional latency, limited data throughput and the additional power that is consumed by the receiver and transmitter and the input/output (I/O) design configuration of the link.

Also when the functionality is split into two dies, there must be a way to transfer the system status signal between the two dies. An interrupt controller related connectivity in a multiple die system is one example of an application in which a status signal transfer is required to carry out the intended function of the multiple die system. An example of a single line interrupt signal connection between multiple dies is shown in FIG. 1 and an example of a parallel line interrupt signal connection between multiple dies is shown in FIG. 2.

In the example shown in FIG. 1, an on-chip-interconnect implementation in an application specific integrated circuit is generally designated 10. In this example, the functionality is split into two dies. A first die generally designated 12 is connected to a second die generally designated 14 by means of a shared link generally designated 16 which may be a master-slave link. The first die 12 includes a microprocessor 12a, an off-die interface 12b, one or more modules 12c, an interrupt controller 12d in which the off-die interface users including the microprocessor 12a are connected to the input of the off-die interface 12b through a multiplexer 12e all of which are suitably arranged and configured to carry out the intended functionality according to the circuit or system design. The status of the modules 12c is connected via the lead 12g to the die status bus 12h for input to the interrupt controller 12d. An interrupt request (IRQ) signal is sent on the IRQ lead 12i from the interrupt controller 12d to the microprocessor 12a. The second die 14 includes an off-die interface 14a, one or more modules 14b, an interrupt controller 14c all of which are suitably arranged and configured to carry out the intended functionality according to the circuit or system design. The status of the modules 14b is connected via the lead 14d to the die status bus 14e for input to the interrupt controller 14c. The system status signal is transferred from the interrupt controller 14c in die 14 to the system status bus 12h in die 12 via the single line interrupt request connection lead 18.

The single line interrupt request connection lead 18 implementation, shown in FIG. 1, is pin optimized in that just one signal is needed. A straightforward pin optimized implementation is to have a local interrupt controller in die 14. The one bit interrupt request signal is routed over the die boundary and added to the system status signal on bus 12h in die 12. However, interrupt signals have priority levels, which are used to select the order of interrupt handling. The use of a single signal to indicate system status obsoletes a two-interrupt controller based priority usage or at a minimum requires some additional off-die interrupt request signal related logic. Also the software use is complicated because the software cannot know the reason of an interrupt by only reading the interrupt from one place. The solution shown in the example in FIG. 1 has multiple levels of interrupt controllers and the software needs to read the interrupt controllers in sequence to find or identify the signal that caused the interrupt. The microprocessor 12a needs to access the off-die interrupt controller through off-die link 16, which adds latency and thus wastes microprocessor power. Further, the system status signals can be used for meanings other than interrupts in which case the microprocessor must continually operate over the die boundary at all times.

In the example shown in FIG. 2, an on-chip-interconnect implementation in an application specific integrated circuit is generally designated 20. In this example, the functionality is split into two dies. A first die generally designated 22 is connected to a second die generally designated 24 by means of a shared link generally designated 26 which may be a master-slave link. The first die 22 includes a microprocessor 22a, an off-die interface 22b, one or more modules 22c, an interrupt controller 22d in which the off-die interface users including the microprocessor 22a are connected to the input of the off-die interface 22b through a multiplexer 22e all of which are suitably arranged and configured to carry out the intended functionality according to the circuit or system design. The status of the modules 22c is connected via the lead 22g to the die status bus 22h for input to the interrupt controller 22d. An interrupt request (IRQ) signal is sent on the IRQ lead 22i from the interrupt controller 22d to the microprocessor 22a. The second die 24 includes an off-die interface 24a, one or more modules 24b, an interrupt controller multiplexer 24c all of which are suitably arranged and configured to carry out the intended functionality according to the circuit or system design. The status of the modules 24b is connected via the lead 24d to the die status bus 24e for input to the interrupt controller multiplexer 24c. The system status signal is transferred from the interrupt controller 24c in die 24 to the system status bus 22h in die 22 via the parallel signal interrupt request connection leads 28.

The parallel signal interrupt request connection is generally limited to use in prototypes having multiple field programmable gate arrays (FPGA) or similar type chips. Usually the prototypes are large and not necessarily battery powered. In these instances, the complexity of the design for signal routing and the availability of very large packages is the main limitation for the parallel status signal connection method. Further, the parallel status signal connection method is generally not suitable for production products.

The number of status signals can be bit optimized by using multiplexers such as for example the interrupt controller multiplexer 24c shown in FIG. 2. The idea of the optimization is to select the parallel interrupts at the time of each application and thus limit the number of signals. In operation there will be still tens of signals needed at the same time. In addition, a multiplexer based solution such as described in the example of FIG. 2 needs frequent software control because the used interrupts have to be changed in each use.

What is needed therefore is a way to transfer system status information between multiple dies that overcomes the design and operational drawbacks of known solutions.

### SUMMARY

In accordance with a first broad aspect of the invention, at least two suitably arranged circuits located on a die surface are operatively connected via a shared link. The shared link is configured for carrying data information content between the at least two suitably arranged circuits. A suitably arranged and configured system status signal is transferred between a first of the at least two suitably arranged circuits and a second of the at least two suitably arranged circuits via the shared link for mirroring a system status of the first of the at least two suitably arranged circuits in the second of the at least two suitably arranged circuits. In some embodiments, the first of the at least two suitably arranged circuits and the second of the at least two suitably arranged circuits are located on the surface of the same die. In some embodiments, the first of the at least two suitably arranged circuits is located on the surface of a first die and the second of the at least two suitably arranged circuits is located on the surface of a second die. In some embodiments, the first die and the second die are arranged and configured as a host/peripheral die pair. In some embodiments, one of the at least two suitably arranged circuits comprises a microprocessor. In some embodiments, the system status signal is arranged and configured as part of the data information content carried between the at least two suitably configured circuits. In some embodiments, the system status signal comprises a collection of bit signals arranged and configured for indicating a status of a corresponding on-chip-interconnect access in the first of the at least two suitably arranged circuits. In some embodiments, the collection of bit signals in the second of the at least two suitably arranged circuits are converted for updating in the second of the at least two suitably arranged circuits the status change to the on-chip-interconnect accesses in the first of the at least two suitably arranged circuits. In some embodiments, the system status signal comprises a collection of single bit signals. In some embodiments, the system status signal comprises a collection of parallel bit signals. In some embodiments, a data packet structure is arranged and configured for identifying suitable information for the data information content and the system status signal. In some embodiments, the shared link is configured as a fragmented data interconnect link. In some embodiments, the shared link is configured as a high-speed synchronous serial interface link.

In a second broad aspect of the invention, a device comprises one or more modules arranged and configured for operatively connecting at least two suitably arranged circuits located on a die surface via a shared link, one or more modules arranged and configured for configuring the shared link for carrying data information content between the at least two suitably arranged circuits, and one or more modules arranged and configured for transferring a suitably arranged and configured system status signal between a first of the at least two suitably arranged circuits and a second of the at least two suitably arranged circuits via the shared link for mirroring a system status of the first of the at least two suitably arranged circuits in the second of the at least two suitably arranged circuits. In some embodiments, the device comprises a mobile communication device.

In a third broad aspect of the invention, an apparatus comprises means for operatively connecting at least two suitably arranged circuits located on a die surface via a shared link, means for configuring the shared link for carrying data information content between the at least two suitably arranged circuits, and means for transferring a suitably arranged and configured system status signal between a first of the at least two suitably arranged circuits and a second of the at least two suitably arranged circuits via the shared link for mirroring a system status of the first of the at least two suitably arranged circuits in the second of the at least two suitably arranged circuits.

In a fourth broad aspect of the invention, a device comprises a first suitably arranged and configured circuit located on a die surface, a second suitably arranged and configured circuit located on a die surface, and a shared link arranged and configured for operatively connecting the first suitably arranged and configured circuit located on the die surface to the second suitably arranged and configured circuit located on the die surface for transferring a suitably arranged and configured system status signal between the first suitably arranged and configured circuit and the second suitably arranged and configured circuit for mirroring the system status of the first suitably arranged and configured circuit in the second suitably arranged and configured circuit. In some embodiments, the first suitably arranged and configured circuit is located on a first die surface and the second suitably arranged and configured circuit is located on a second die surface. In some embodiments, the first die surface and the second die surface comprise a surface of a single die. In some embodiments, at least one of the first suitably arranged and configured circuit or the second suitably arranged and configured circuit comprises a microprocessor. In some embodiments, the first suitably arranged and configured circuit comprises an on-chip-interconnect implementation, and the second suitably arranged and configured circuit comprises an on-chip-interconnect implementation.

In a fifth broad aspect of the invention, a device comprises a first die comprising microprocessor controlled cellular modem logic, a second die comprising an evolved universal terrestrial radio access network hardware accelerator, a shared link arranged and configured as a die input/output interface for connecting the first die to the second die such that the microprocessor is enabled with off-die access to and from the second die, a status mirror host located on the second die for collecting bit signals arranged and configured as a system status signal for indicating a status of a corresponding on-chip-interconnect access in the second die, and a status mirror target located on the first die arranged and configured for receiving the system status signal and for converting the system status signal back to individual bit signals representative of the status of the corresponding on-chip-interconnect accesses in the second die such that the system status of the second die is mirrored in the first die.

### BRIEF DESCRIPTION OF THE DRAWINGS

Other features and benefits of the invention will become readily apparent from the following written description of exemplary embodiments taken in conjunction with the drawing figures wherein:

FIG. 1 is a functional circuit block diagram showing an example of an application specific integrated circuit having a single line interrupt request connection between multiple dies.

FIG. 2 is a functional circuit block diagram showing an example of an application specific integrated circuit having a parallel signal interrupt request connection between multiple dies.

FIG. 3 shows a flowchart of the basic steps of the method for mirroring a system status signal between circuits located on a die surface according to some embodiments of the present invention.

FIG. 4 shows a mirrored system status signal enabled device in the form of a mobile communication device according to some embodiments of the present invention.

FIG. 5 shows a basic implementation for system status signal transfer between suitably configured circuits located on the respective surfaces of two different dies in accordance with some embodiments of the present invention.

FIG. 6 shows a basic implementation for a status mirror system according to some embodiments of the present invention.

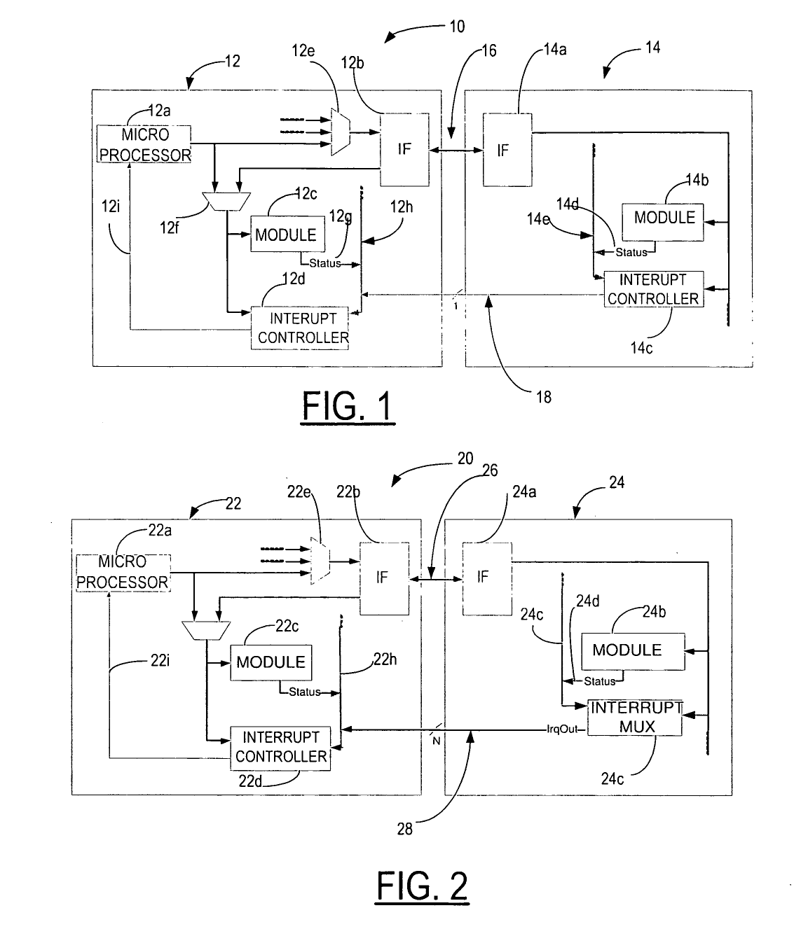

### DETAILED DESCRIPTION

According to some embodiments the present invention provides a way for solving the problem of mirroring system status signals between multiple dies that are connected together. The multiple dies may be separate and located for example on a printed wiring board (PWB), or they may be stacked together, or they may be arranged or configured for carrying out their respective intended functionality in any suitable manner as now known or developed in the future. The scope of the invention is not intended to be limited to mirroring system status signals between such multiple dies that are connected together as will become readily apparent from the description herein.

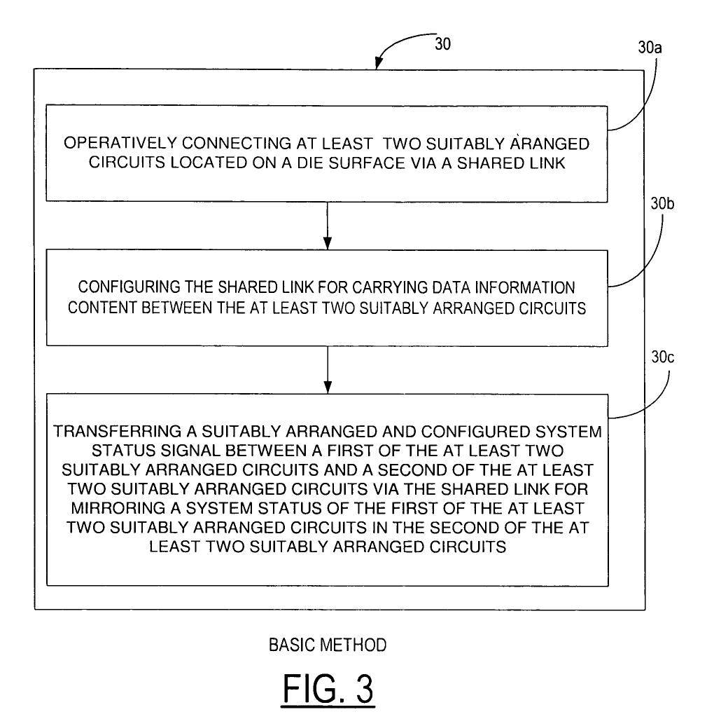

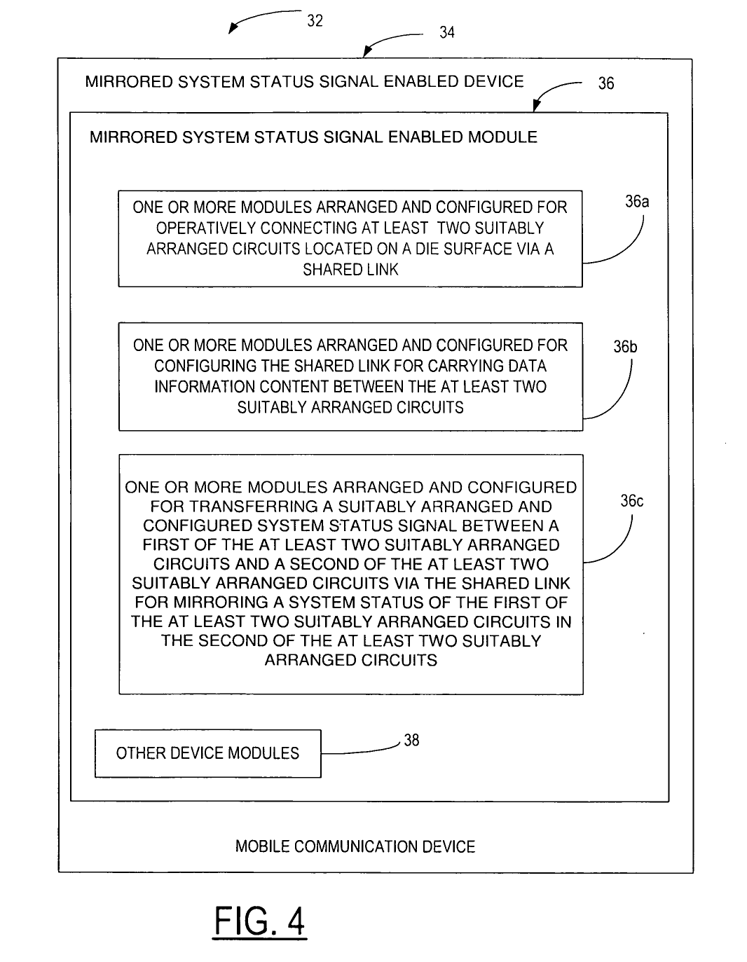

FIG. 3 shows a flowchart generally designated as 30 having basic steps or actions 30a, 30b, 30c for implementing the inventive method according to some embodiments of the present invention, for example in a suitable electronic device or apparatus, comprising operatively connecting at least two suitably arranged circuits located on a die surface via a shared link (step 30a), configuring the shared link for carrying data information content between the at least two suitably arranged circuits (step 30b), and transferring a suitably arranged and configured system status signal between a first of the at least two suitably arranged circuits and a second of the at least two suitably arranged circuits via the shared link for mirroring a system status of the first of the at least two suitably arranged circuits in the second of the at least two suitably arranged circuits (step 30c). These steps 30a, 30b and 30c may be implemented in one or more modules configured to do the same in such an electronic device such as for example a mobile communication terminal or such like device. The scope of the invention is not intended to be limited to the order in which the steps or actions in FIG. 4 are performed. Further, the scope of the invention is not intended to be limited to any particular implementation using technology now known or developed in the future for locating the operatively connected circuits on the same die surface or on multiple die surfaces.

It is understood that the aforementioned methods may include other steps known in the art that do not form a part of the underlying invention.

FIG. 4 shows by way of example, a mobile communication device generally designated 32 in the form of a mirrored system status signal enabled device generally designated 34 according to some embodiments of the present invention. The mirrored system status enabled device 34 has one or more mirrored system status signal enabled modules 36 including a module 36a arranged and configured for operatively connecting at least two suitably arranged circuits located on a die surface via a shared link, a module 30b arranged and configured for configuring the shared link for carrying data information content between the at least two suitably arranged circuits, and a module 36b arranged and configured for transferring a suitably arranged and configured system status signal between a first of the at least two suitably arranged circuits and a second of the at least two suitably arranged circuits via the shared link for mirroring a system status of the first of the at least two suitably arranged circuits in the second of the at least two suitably arranged circuits.

Consistent with that described above, the mirrored system status signal enabled device 34 is shown in the form of a mobile communication device 32 or other suitable electronic device now known or developed in the future. The mirrored system status signal enabled device 34 may also have other device modules 38 that do not form part of the underlying invention and are not described in detail herein.

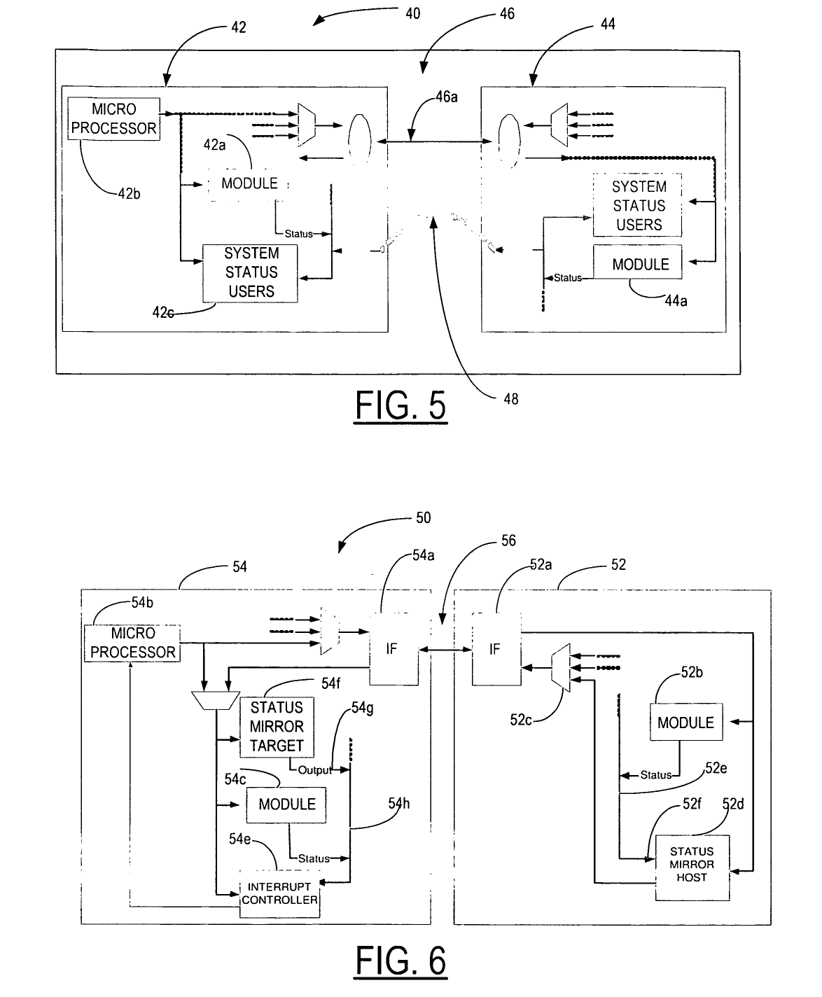

In accordance with some embodiments of the invention for example as shown in an implementation generally designated 40 in FIG. 5 the main design entities contemplate a wideband code division multiple access (WCDMA) and global system for mobile communication (GSM) cellular modem logic module including microprocessor resources and a suitable logic module configured as a plain hardware accelerator. The two modules are split between two different dies and require a link over die boundary to connect them. The processor core and the logic that it is controlling are fabricated into two separate dies. The split is done for purposes of scheduling, flexibility and available silicon die area. A first die 42 is configured with one or more modules generally designated 42a including for example a modem logic module, which is arranged with a microprocessor 42b. A second die 44 is configured with one or more modules generally designated 44a including for example a hardware accelerator logic module. In this example, the hardware accelerator logic module does not have a microprocessor. The first die 42 and second die 44 are connected via a suitable shared off-die link generally designated 46 which functions as the die-to-die input/output interface. The shared off-die link 46 is configured and arranged with a suitable wire or conductor 46a for carrying data information content in accordance with the intended functions of the respective modules in a first direction between the first die 42 and the second die 44, and in a second direction opposite the first direction from die 44 to die 42 for carrying data information content in accordance with the intended functions of the respective modules. The microprocessor 42b controls the modem logic module 42a of the first die 42 and the off-die hardware accelerator logic module 44a of the second die 44 via the shared off-die link 46.

According to some embodiments of the invention, the status of the modules 44a on die 44 is collected and mirrored back to the die 42 to update the system status users 42c on die 42 without using dedicated pins or connections between the two dies 42 and 44 as indicated by the dashed line 48 between the two dies 42 and 44 in FIG. 5. The mirroring of the status of the die 44 to the die 42 allows the software to operate as though the system is actually on one die rather than working across die boundaries. The effect is the same as having multiple parallel inputs/outputs however the status signal is not transferred directly because there is no connection between the dies to carry the system status signal information.

According to some embodiments of the present invention, status signals are changed on one die to suitable system operations for example bus accesses or some similar system operation and transferred to the other die using the available communication link operatively connecting the two dies. In this example, the bus accesses transferred to the other die are then changed back or converted to status signals and thus they look and operate as normal status signals as though the status signal was present in the die itself. In this example, the system stats signal is arranged and configured as part of the data information content that is carried by the shared link that operatively connects the two dies together. The system status transfer solution should meet performance requirements, be simple enough for easy use and implementation and inexpensive. Further the implementation should be able to be carried out on different technologies for example application specific integrated circuit technology and field programmable gate array technology. The scope of the invention is not intended to be limited to any particular implementation using technology now known or developed in the future.

According to some embodiments of the present invention, the shared link operatively connecting the dies together may be implemented in any suitable arrangement and configuration to carry out the intended function. The shared link has to be sufficiently fast and always provide low transfer latency, which basically means that the shared link implementation has some hardware level link user arbitration. According to some embodiments of the present invention, a fragmented data interconnect (FDI) link may be utilized as the shared link operatively connecting the two dies together. The fragmented data interconnect link is a parallel data interface that generally provides a seamless off-die extension for an on-chip-interconnect. A fragmented data interconnect link requires link arbitration in front of a fragmented data interconnect transmitter. According to some embodiments of the present invention, a high-speed synchronous serial interface (HSI) may be utilized as the shared link operatively connecting the two dies together. A high-speed synchronous serial interface is a serial interconnect and offers logical channels over a single physical link (i.e. the user arbitration is built into the interconnect definition).

The scope of the invention is not intended to be limited to any particular implementation using technology now known or developed in the future for providing the shared link for operatively connecting the two dies together.

With reference to FIG. 6 a basic implementation for a status mirroring system according to some embodiments of the present invention is shown therein and generally designated 50. The status mirroring system can be broken into smaller functional entities which can be broadly described according to the following. First, the individual statuses are collected to a collective status signal. The collective status signal changes are monitored and mirrored autonomously over a shared off-die link from the origination die to the destination die. On the destination die the mirrored status is concatenated to the destination die system status signal. In the example shown in FIG. 6, a first die 52 is arranged and configured as an evolved universal terrestrial radio access network (EUTRAN) hardware accelerator, and a second die 54 is arranged and configured as a wideband code division multiple access and global system for mobile communications cellular modem logic (WGModem). The die 52 includes a first suitably arranged and configured circuit including an off-die interface 52a, one or more modules 52b, an off-die interface user multiplexer 52c, and a status mirror host 52d, all of which are arranged and configured to carry out the intended functionality. The die 54 includes a second suitably arranged and configured circuit including an of-die interface 54a, a suitable signal processor 54b such as a digital signal processor or microprocessor for controlling the operation to carry out the intended functionality, one or more modules 54c, an off-die interface user multiplexer 54d, an interrupt request controller 54e, and a status mirror target 54f all of which are arranged and configured to carry out the intended functionality. A suitably arranged and configured shared link generally designated 56 operatively connects the two dies 52 and 54 together via the respective off-die interfaces 52a and 54a and carries the data information content between the two dies. In this example, die 52 is considered a peripheral die and the system status signal on lead 52e collects all the module status outputs that are followed or monitored by die 54 which is considered in this example to be the host die. The die 52 system status signal is connected to the status input 52f of the status mirror host 52d. The status host mirror 52d converts the status input which can be a value or just changes to the status input to on-chip-interconnect accesses or posted writes. The on-chip-interconnect accesses are routed to the status mirror target 54f on die 54 via the shared off-die interconnect link 56. The status mirror target 54f on die 54 converts the on-chip-interconnect status update accesses received from the status mirror host on die 52 to its status output on lead 54g which is connected to the die 54 system status signal on lead 54h. The system collective status signal on lead 54h is in turn connected to a corresponding module 54c that is deploying the die 52 module status.

It is to be understood that the above-described arrangements are only illustrative of the application of the principles of the present invention and are not to be construed as limitations of the invention. Numerous modifications and alternative arrangements may be devised by those skilled in the art without departing from the scope of the invention and the appended claims are intended to cover such modifications and arrangements. Further, the invention contemplates all embodiments that may be inferred directly or indirectly from the disclosure and drawings whether or not expressly stated and claimed.

1. A method, comprising:
operatively connecting at least two suitably arranged circuits located on a die surface via a shared link;
configuring said shared link for carrying data information content between said at least two suitably arranged circuits; and
transferring a suitably arranged and configured system status signal between said at least two suitably arranged circuits via said shared link for mirroring a system status of one of said at least two suitably arranged circuits in the other of said at least two suitably arranged circuits.

2. The method according to claim 1 further comprising locating said one of said at least two suitably arranged circuits and said other of said at least two suitably arranged circuits on the surface of the same die.

3. The method according to claim 1 further comprising locating said one of said at least two suitably arranged circuits on the surface of a first die and locating said other of said at least two suitably arranged circuits on the surface of a second die.

4. The method according to claim 3 further comprising arranging and configuring said first die and said second die as a host/peripheral die pair.

5. The method according to claim 4 wherein one of said at least two suitably arranged circuits comprises a microprocessor.

6. The method according to claim 1 further comprising arranging and configuring said system status signal as part of said data information content carried between said at least two suitably configured circuits.

7. The method according to claim 4 wherein said system status signal comprises a collection of bit signals arranged and configured for indicating a status of a corresponding on-chip-interconnect access in said one of said at least two suitably arranged circuits.

8. The method according to claim 7 further comprising converting said collection of bit signals in said other of said at least two suitably arranged circuits for updating in said other of said at least two suitably arranged circuits the status change to said on-chip-interconnect accesses in said one of said at least two suitably arranged circuits.

9. The method according to claim 6 wherein said system status signal comprises a collection of single bit signals.

10. The method according to claim 6 wherein said system status signal comprises a collection of parallel bit signals.

11. The method according to claim 8 further comprising arranging and configuring a data packet structure for identifying suitable information for said data information content and said system status signal.

12. The method according to claim 1 further comprising configuring said shared link as a parallel data interconnect link.

13. The method according to claim 1 further comprising configuring said shared link as a high speed synchronous serial interface link.

14. An apparatus, comprising:
one or more modules arranged and configured to operatively connect at least two suitably arranged circuits located on a die surface via a shared link;
one or more modules arranged and configured to configure said shared link to carry data information content between said at least two suitably arranged circuits; and
one or more modules arranged and configured to transfer a suitably arranged and configured system status signal between one of said at least two suitably arranged circuits and the other of said at least two suitably arranged circuits via said shared link to mirror a system status of said one of said at least two suitably arranged circuits in said other of said at least two suitably arranged circuits.

15. The apparatus according to claim 14 comprising a mobile communication device.

16. An apparatus, comprising:
means for operatively connecting at least two suitably arranged circuits located on a die surface via a shared link;
means for configuring said shared link for carrying data information content between said at least two suitably arranged circuits; and
means for transferring a suitably arranged and configured system status signal between one of said at least two suitably arranged circuits and another of said at least two suitably arranged circuits via said shared link for mirroring a system status of said one of said at least two suitably arranged circuits in said another of said at least two suitably arranged circuits.

17. An apparatus, comprising:
a first suitably arranged and configured circuit located on a die surface;
a second suitably arranged and configured circuit located on a die surface; and
a shared link arranged and configured for operatively connecting said first suitably arranged and configured circuit located on said die surface to said second suitably arranged and configured circuit located on said die surface for transferring a suitably arranged and configured system status signal between said first suitably arranged and configured circuit and said second suitably arranged and configured circuit to mirror the system status of said first suitably arranged and configured circuit in said second suitably arranged and configured circuit.

18. The apparatus according to claim 17 wherein said first suitably arranged and configured circuit is located on a first die surface and said second suitably arranged and configured circuit is located on a second die surface.

19. The apparatus according to claim 18 wherein said first die surface and said second die surface comprise a surface of a single die.

20. The apparatus according to claim 17 wherein at least one of said first suitably arranged and configured circuit or said second suitably arranged and configured circuit comprises a microprocessor.

21. The apparatus according to claim 17 further comprising:
said first suitably arranged and configured circuit comprising an on-chip-interconnect implementation, and
said second suitably arranged and configured circuit comprising an on-chip-interconnect implementation.

22. An apparatus, comprising:
a first die comprising microprocessor controlled cellular modem logic;
a second die comprising an evolved universal terrestrial radio access network hardware accelerator;
a shared link arranged and configured as a die input/output interface for connecting said first die to said second die such that said microprocessor is enabled with off-die access to and from said second die;
a status mirror host located on said second die for collecting bit signals arranged and configured as a system status signal for indicating a status of a corresponding on-chip-interconnect access in said second die;
a status mirror target located on said first die arranged and configured for receiving said system status signal and for converting said system status signal back to individual bit signals representative of the status of said corresponding on-chip-interconnect accesses in said second die such that the system status of said second die is mirrored in said first die.
